(19) United States
(12) Patent Application Publication
(10) Pub. No.: US 2005/0192944 A1
(43) Pub. Date: Sep. 1, 2005

(54) A METHOD AND APPARATUS FOR SEARCHING LARGE DATABASES VIA LIMITED QUERY SYMBOL SETS

(75) Inventor: Edward P. Flinchem, Seattle, WA (US)

Correspondence Address: BLACK LOWE & GRAHAM, PLLC, 701 FIFTH AVENUE, SUITE 4800, SEATTLE, WA, 98104, US

(73) Assignee: MELODEO, INC., Seattle, WA (US)

(21) Appl. No.: 10/906,608

(22) Filed: Feb. 25, 2005

Related U.S. Application Data
(60) Provisional application No. 60/548,589, filed on Feb. 27, 2004.

(51) Int. Cl. G06F 17/30

(52) U.S. Cl. 707/3

(57) ABSTRACT

Methods and systems for searching a database that includes a plurality of records. Each record includes one or more tokens. The one or more tokens include one or more letters, numbers, or symbols. The system includes a user interface that when activated by a user generates at least one of a query symbol or a string of query symbols. A processing device compares the generated query symbol or string of query symbols to the stored records. An output device presents the record or records having tokens that match the generated query symbol or a string of query symbols based on the comparison. The user interface includes two or more input keys. Each input key is associated with a query symbol and the number of input keys is less than the number of distinct letters, characters, and symbols.

### CROSS-REFERENCE TO RELATED APPLICATIONS

This invention claims priority to U.S. Provisional Application Ser. No. 60/548,589, filed Feb. 27, 2004, the contents of which are hereby incorporated by reference.

### BACKGROUND OF THE INVENTION

Currently there is not a way to simply, quickly, and easily compose a query for a database where the query is expressed using a set of symbols different from the set used to represent the data being queried and having a smaller number of distinct symbols than distinct searchable entities in the database. For example, a phone having 9 or so input keys cannot presently be employed to search a database that includes records that may include a combination of numbers, letters or symbols.

### BRIEF SUMMARY OF THE INVENTION

The present invention provides methods and systems for searching a database that includes a plurality of records. Each record includes one or more tokens. The one or more tokens include one or more letters, numbers, or symbols. The system includes a user interface that when activated by a user generates at least one of a query symbol or a string of query symbols. A processing device compares the generated query symbol or string of query symbols to the stored records. An output device presents the record or records having tokens that match the generated query symbol or a string of query symbols based on the comparison. The user interface includes two or more input keys. Each input key is associated with a query symbol and the number of input keys is less than the number of distinct letters, characters, and symbols.

### BRIEF DESCRIPTION OF THE SEVERAL VIEWS OF THE DRAWING

FIGS. 1 and 2 are diagrams showing system formed in accordance with an embodiment of the present invention; and

FIG. 3 is a flow diagram illustrating a process formed in accordance with an embodiment of the present invention.

### DETAILED DESCRIPTION OF THE INVENTION

Given a database of tens, hundreds, thousands, or even more records, each record being allowed to be of variable length but not required, and all records being represented in a character set of a given number of distinct symbols (typically in the range of 32 to 128 symbols, such as ASCII, but not restricted to that range). The present invention includes methods and apparatus whereby a user may simply, quickly, and easily compose a query for the database. The query is expressed using a set of symbols different from the set used to represent the data being queried (even using a symbol set completely disjoint from that being searched but related to it systematically). The set of query symbols has a smaller number of distinct members than distinct members used in the database (typically in the range of one half to one tenth the number of distinct symbols but not restricted to that range).

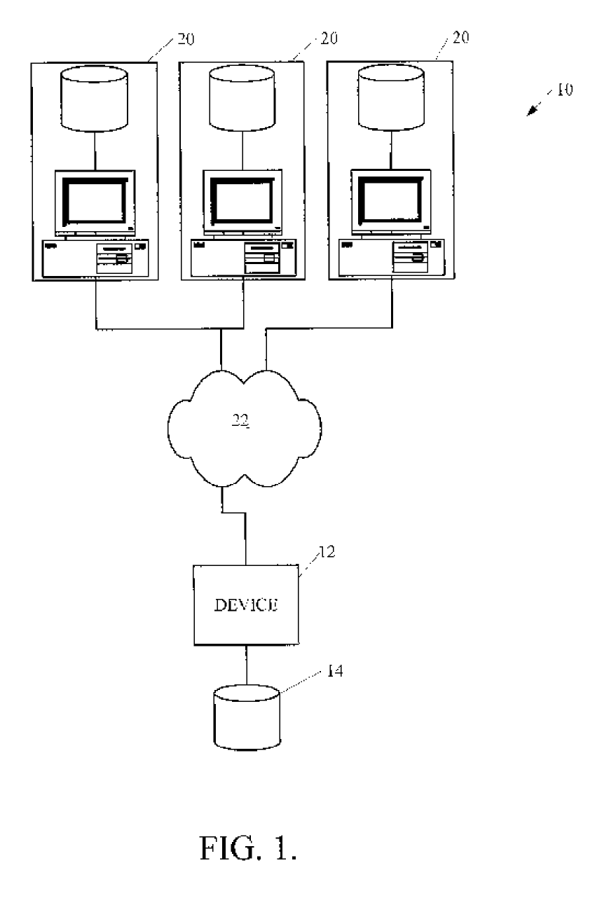

As shown in FIG. 1, a system 10 includes a device 12, a memory device 14 linked with the device 12, and one or more database storage systems 20. In one embodiment, the database storage systems 20 are accessible by the device 12 over a network 22. The network 22 may be a wired or wireless network or any combination of wired and wireless networks. The database being searched may be located in the memory device 14 or any of the database storage systems 20 or may be distributed across any or all of the memory device 14 and the database storage systems 20. The memory device 14 may be a storage device located within the device 12. The device 12 may be any of a number of devices, such as a cell phone, personal data assistant, or any device that has more that two searchable entities associated with at least one input key/switch.

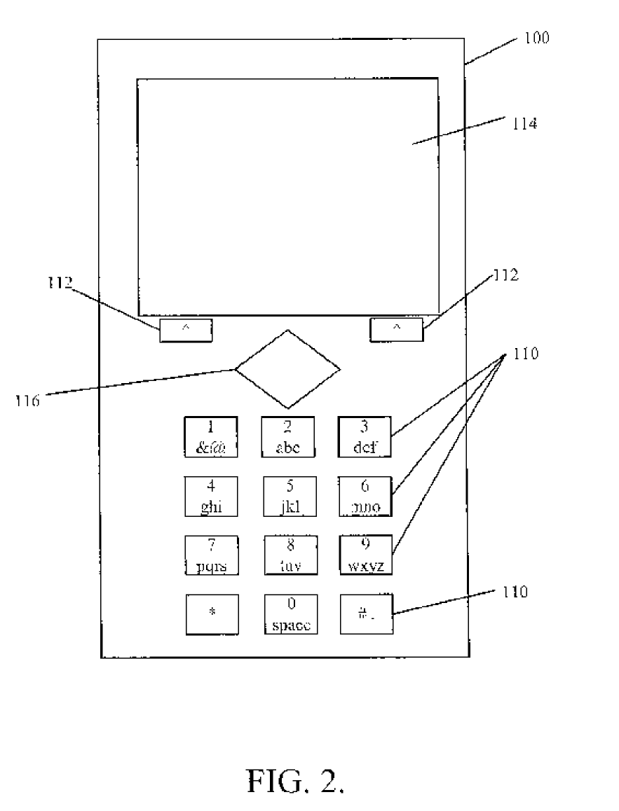

As shown in FIG. 2, a cell phone 100 is an example of the device 12 of FIG. 1. The cell phone includes input keys 110, a display 114, and other interface keys, such as display interface keys 112 and a multi-directional toggle 116. One or more of the keys 110 are associated with two or more letters, numbers, or symbols. Activation of the keys 110 during a search mode of the phone 100 generates query symbols that are associated with the activated keys. Then, the database is searched using the query symbols. The display 114 presents results of the search.

The keys 110 may be in the form of a graphical user interface, switches, or other form or forms of electrical, mechanical, magnetic, optical, or capacitive sensing devices, which a user might manipulate to produce electrical inputs comparable to opening and closing mechanical switches in order to compose a query one symbol at a time.

In one embodiment, the records in the database are stored associated with a particular order of priority, which may be based on any of several factors or combinations thereof. For example, factors include the number of retrievals of each record in the past by a population of users, the timeliness of the records by a date inherent in each, the timeliness of the records by the date each was created in the database, the timeliness of the records by the date and time of the last instance each was retrieved, the rate of retrievals of each record over a certain time window by a set population, a count of references to each record in other searchable data storage repositories (such as the internet), the relevancy of each record relative to information concerning the user (such as but not limited to his or her objectively measured tastes, age, gender, income, geographical position, previously expressed preferences), alphabetical order (or other externally defined sorting order), or at random. The display 114 presents as many of the found highest priority records from the database (in priority sorted order) as will fit in available display space.

In one embodiment, the result of a search is defined as all the records in the database in order from highest priority down. The interface of the device allows for all the results of a search to be scrolled through the display in order from highest priority to lowest priority, a line at a time, and a screen full at a time. The occurrence and direction of scrolling is controlled by the user's manipulation of the interface, such as the keys 116. In one embodiment, one record in the display 114 is always visually indicated as the candidate result of a search, which by default is the highest priority result each time search results are computed, unless and until the user scrolls the selection highlight after the update. If multiple records are visible simultaneously, the interface enables the selection indication to be moved to any visible record according to manipulation by the user. In one implementation, in the display 114, when the query has non-zero length, one or more contiguous ranges of characters of each record which are the characters matching the query are graphically distinguished, such as bold, underlined, italicized, differently colored, or otherwise distinguished. For example, a region of the display 114 that is distinct from the list of results displays the one or more contiguous ranges of characters of the highlighted record which are the characters matching the query.

The interface enables the search to be finalized at any time by a user activating a selection function. In one implementation, the search may auto-finalize upon the expiration of a timer if the user neither scrolls the results nor modifies the query for more than a set length of time.

Upon each additional symbol of a query being input or deleted, the database is searched for the highest priority matching results and the display 114 is updated with the most recently found results. In one implementation, the number of matching records is displayed and updated dynamically after each change in the query.

Mathematical Preliminaries

For illustration, suppose a database consists of one million, 40 digit, random, decimal numbers. The symbol set of the data is the set of the ten digits: “0”, “1”, . . . “9”. Suppose the symbol set of the queries is limited to only two symbols. How could the database be usefully searched? Let one symbol, “E,” match any even digit (0,2,4,6,8) and one symbol, “O,” match any odd digit (1,3,5,7,9). In a 20 symbol sequence of E's and O's, there are over one million possible combinations. Thus, on average, it should be possible to search for and retrieve any 40 digit number in the database with a search string of only approximately 20 symbols, on a device with only two input keys, given an assumption that the numbers in the database are random.

Range of Applicability

As a general principal, the following conditions are necessary, to a rough approximation, for the present invention to be effective as a search technique, given any database to be searched. Suppose Nr is the number of records of length R characters in the given database (where R may have multiple values). Further suppose, the number of distinct symbols in the query composition set is S and the query symbols map in a one to many manner to the set of distinct symbols of the records to be searched, such that every symbol to be searched maps to at least one query symbol. Lastly, suppose that the number of lines displayable at once in the visual read out of the device is L. Then, the invention is effective if Nr divided by S to the power R is less than or equal to L for all values of R in the given database.

$$\frac{{N}_{r}}{{S}^{R}} \leq L$$

for all values of R.

Even on a one line display L may be greater than 1.

It does not preclude an effective result if there is partial over lapping in the mapping of the record symbols to the search symbols, i.e., if a record symbol maps to more than one search symbol. Although the performance of the invention may be less than if that were not the case.

In the case where the device 12 is a mobile phone, the keys of the dialing pad may be visually marked with an arrangement of letters and numbers. There are also symbols commonly mapped to the keys for which the keys are not graphically marked, but which are nonetheless used by software on the phone. One such mapping arrangement is shown in Table 1. Other arrangements are possible.

| Key Name | Symbols Mapped to Each Key | | | | | | | | |
|---|---|---|---|---|---|---|---|---|---|
| (Query Symbols) | (Symbol Set of Records to be Searched) | | | | | | | | |
| 1 | 1 | . | , | - | ? | ! | ' | @ | : |
| 2 | 2 | a | b | c | á | à | â | ä | [symbol] |
| 3 | 3 | d | e | f | é | è | ê | ë | |
| 4 | 4 | g | h | i | í | ì | î | ï | |
| 5 | 5 | j | k | l | | | | | |
| 6 | 6 | m | n | o | ñ | ó | ò | ô | ö |
| 7 | 7 | p | q | r | s | β | | | |
| 8 | 8 | t | u | v | ú | ù | û | ü | |
| 9 | 9 | w | x | y | z | | | | |
| 0 | space | 0 | | | | | | | |

Definition

Since each key in this example (Table 1) includes a single digit number, it is convenient hereafter to identify the symbols that are mapped to the keys by the digit of the respective key, although this is not required. It is important to distinguish between the names of the keys, which are the symbols used to express queries, and the characters mapped onto the keys, especially since the digit “1” is mapped onto the first key, and the digit “2” is mapped into the second key in this example, and so on. The digits 0-9 as digits (symbols standing for integers) are logically quite distinct from the names, or indices, of the keys onto which a variety of symbols including digits happen to be mapped. To mark this distinction, the names of the query symbols are designated by the digits 0 to 9 with underscores. The query input keys, which in a device are commonly switches or electronic sensors functioning in a manner comparable to switches, may also be referred to by the word “key” followed or preceded by either a digit or a short name sufficient to distinguish exactly one key from a range of keys. When the present invention is applied to a mobile phone, depressing a dialing key, such as key 2 (which might also be written as “key 2abc” or “the abc key”) would cause query symbol 2 to be input to the invention. Depressing key 3 would cause query symbol 3 to be input into the invention, and so one for the other dialing keys.

The set of symbols, or character set, of the data in the database to be search is also called the target character set, individual characters being target characters, and so on.

In any application of the invention, there is a logical mapping of user interface elements (e.g., switches, keys, on screen buttons) to a list of query symbols and a logical mapping of each query symbol to a list of symbols used to represent data in the database to be searched (e.g., Table 1). Wide variations are possible in the number and arrangement of keys and symbols.

Definition of “match”

Matching is an element of the invention that operates at two levels of complexity: single symbols and multiple symbols.

A single symbol match is a relationship between a given query symbol and a target character where the relationship is defined by a mapping table (e.g., Table 1). A query symbol and a target/component/token match if they both occupy a common row in a table comparable to Table 1. Representing the relationship in a table with all query symbols listed once in a single column is merely a convenience to represent the relationship in a compact manner in a document. In a preferred implementation, all target characters are in a one row (or column) of a table and their matching query symbols are identified by an adjoining row (or column), in which case each query symbol will appear several times.

A query of multiple symbols matches a particular target record only if all of its symbols individually match targets in the particular record.

Shift State

In one implementation, shift state, the distinction between upper case and lower case, is incorporated into the invention. In the preferred implementation, upper case and lower case versions of the targets are treated as being identical, e.g., “A” is the same as “a” and either matches 2 in the case of Table 1.

Definition of Database

A database is an aggregation of information into one or more distinct records, each record being a mixed or uniform collection of characters, numbers, or other data types, each record being finite in size, though not necessarily all of one size. The simplest example of a database is a file of text where each record is separated from the next by one or more record separator characters.

Division of Records into Tokens or Words

In many applications of the present invention, such as searching a database of directory information (e.g., persons, businesses, government offices, and comparable lists) or catalogs of items such as might be found in a store or library or warehouse, the database records may be usefully further divided into words or tokens (i.e., sequences of characters with a common characteristic confined between logical boundaries). In the English language, the boundaries between word tokens may be white space or any of a number of different punctuation marks, while the substance of word tokens is confined to the letters of the alphabet, plus hyphen and apostrophe.

In one embodiment, continuous mixed sequences of letters and digits are defined as tokens, i.e., “3COM,” is a valid token.

In one embodiment, continuous sequences of digits bounded by any non-digits are tokens.

In one embodiment, token boundaries may overlap. For example, the sequence “poly1234” is three tokens: “poly,” “1234,” and “poly1234.”

Different embodiments of the invention may use various combinations of the above rules.

Search

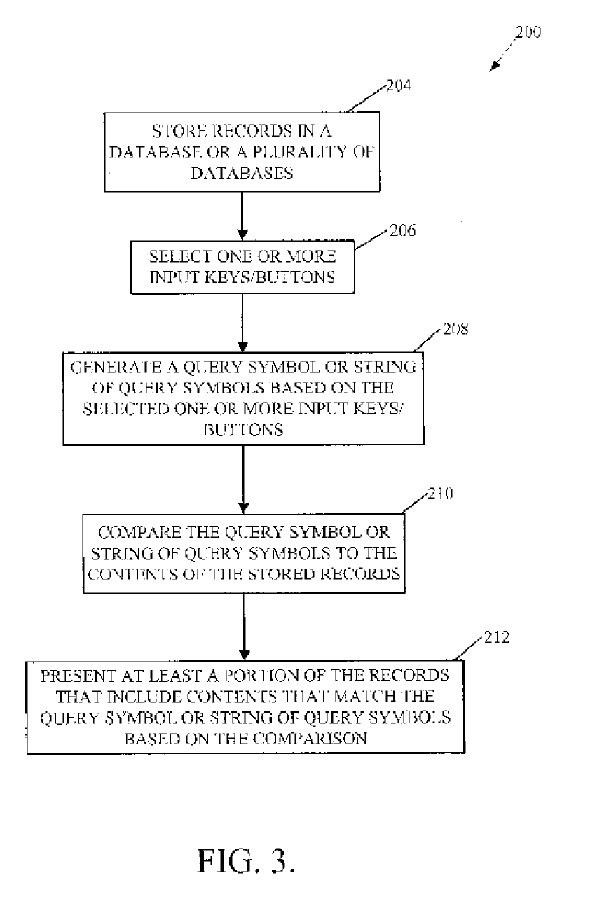

FIG. 3 illustrates an example process 200 performed by the device 12 of FIG. 1. At a block 204, records are stored in a database. At a block 206, one or more input keys/buttons are selected by a user. At a block 208, a query symbol or string of query symbols is generated based on the selected one or more input keys/buttons. At a block 210, the generated query symbol or string of query symbols is compared to the contents of the stored records. At a block 212, at least a portion of the records that include contents that match the query symbol or string of query symbols is presented based on the comparison.

In one embodiment, the present invention (a processor coupled to memory and user interface devices, all of which are included in the device 12) searches a database in a manner organized into tokens. When the first symbol of a query is input, matching records are those containing any token(s) where the initial character matches the first symbol of a query. When the second symbol of a query is input, the matching records are those containing any token where the initial two characters match the two query symbols in the same order as the entered query symbols. Matching continues in the same manner for additional symbols input into the query.

In another embodiment, the present invention (a processor coupled to memory and user interface devices, all of which are included in the device 12) searches a database in a manner organized into tokens. When the first symbol of a query is input, matching records are those containing any token(s) where any character matches the first symbol of a query. When the second symbol of a query is input, the matching records are those containing any token where any two successive characters match the two query symbols in the same order as the entered query symbols. Matching continues in the same manner for additional symbols input into the query. Thus, the query string 383 could match both of the following targets “steve” and “eve.”

Typographical, spelling, or other errors are examples of exceptions to searching the exact order of the entered query symbols. For example, in one embodiment, records including the “ie” and “ei” match the query symbols 43.

Queries are not limited to searching for single tokens. In one embodiment, an additional key is provided in the device 12 for dividing the query into sections, e.g., before and after. The query symbols inputted prior to activation of the additional key will match any target tokens as a before match, while query symbols input after activation of the additional key will only match target tokens as if they were the initial symbols of a query. The query dividing key may be used to compose a query of as many parts (or terms) as desired. Matching records are only those containing tokens matching all components of a multi-term query. In one embodiment, matching records are only those containing tokens matching all components of a multi-term query in the same order as the queries were input. In another embodiment, the matching target tokens are not required to be in the same order as the query terms, but matching records where the tokens are in the same order as the query tokens may be assigned a higher priority and may be displayed earlier on a display, such as the display 114, FIG. 2.

Implicit boundaries between query terms are enabled and query terms may overlap. For example, in Table 1, query symbol 0 matches both space and the digit zero. Thus, in one embodiment, the query symbols 36905 match both “fox jumps” and “dm905 please”.

In one embodiment, single query terms are enabled to cross boundaries between adjacent target tokens even when the query symbols contains no symbol to match an inter-token boundary in the target. For example, the query symbols 843 matches the following record where the matching target characters are indicated by an underscore: “the long theorem.” If the query symbols were extended to 8436 the result would be: “the long theorem.” But, if the query symbols were extended to 8435 the result would be: “the long theorem.”

In one embodiment, the function of dividing a query symbol string is combined with the query symbol matching space. Thus, the input of multiple, short query terms to match multiple, longer target tokens is enabled, even for very limited key pads. For example, the query symbols 74092 would match the following target: “Pink Floyd: the Wall.”

In another embodiment, the device 12 includes an any or all keys such as an asterik or star key, that when selected generates a query symbol that is comparable to simultaneously selecting all the keys associated with a query symbol and/or generates a query symbol that matches all the distinct letters, numbers, and symbols.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

1. A method of searching a database having a plurality of records, each record including one or more tokens, wherein the one or more tokens include one or more letters, numbers, or symbols, the method comprising:
generating at least one of a query symbol or a string of query symbols using two or more input keys, wherein each input key is associated with a query symbol and the number of input keys is less than the number of distinct letters, characters, and symbols;
comparing the generated query symbol or string of query symbols to the stored records; and
if based on the comparison the query symbol or string of query symbols match token or tokens of a record, outputting the record or records having the matching tokens on a display associated with the input keys.

2. The method of claim 1, wherein generating is performed using at most 10 input keys.

3. The method of claim 1, wherein a blank space is mapped to one of the input keys.

4. The method of claim 1, further comprising:
generating a delimiter function; and
separating query symbols that are entered after generation of the delimiter function from one or more query symbols that were entered before generation of the delimiter function.

5. The method of claim 4, wherein the key associated with a delimiter function includes an input key that is mapped with a space entering function.

6. The method of claim 4, wherein a record is determined to match the separated query symbols if the record includes at least portions of tokens that match the separated query symbols.

7. The method of claim 6, wherein the matching portions of tokens are in the same order as the separated query symbols.

8. The method of claim 6, wherein the matching portions of tokens are not in the same order as the separated query symbols.

9. The method of claim 1, wherein comparing includes:
determining if at least a portion of a string of query symbols is associated with a predefined spelling rule;
searching the database according to the associated spelling rule; and
outputting results based on the search.

10. The method of claim 1, generating an all query symbol that matches all the distinct letters, numbers, and symbols.

11. A system for searching a database that includes a plurality of records, each record includes one or more tokens, the one or more tokens include one or more letters, numbers, or symbols, the system comprising:
a user interface for generating at least one of a query symbol or a string of query symbols;
a processing device for comparing the generated query symbol or string of query symbols to the stored records; and
an output device for presenting the record or records having tokens that match the generated query symbol or a string of query symbols based on the comparison,
wherein the user interface includes two or more input keys, wherein each input key is associated with a query symbol and the number of input keys is less than the number of distinct letters, characters, and symbols.

12. The system of claim 11, wherein the means for generating includes at most 10 input keys.

13. The system of claim 11, wherein a blank space is mapped to one of the input keys.

14. The system of claim 11, further comprising:
a user interface component for generating a delimiter function; and
a means for separating query symbols that are entered after generation of the delimiter function from one or more query symbols that were entered before generation of the delimiter function.

15. The system of claim 14, wherein the user interface component that generates the delimiter function is mapped with a space entering function.

16. The system of claim 14, wherein a record is determined to match the separated query symbols if the record include at least portions of tokens that match the separated query symbols.

17. The system of claim 16, wherein the matching portions of tokens are in the same order as the separated query symbols.

18. The system of claim 16, wherein the matching portions of tokens are not in the same order as the separated query symbols.

19. The system of claim 11, wherein the means for comparing includes:
a means for determining if at least a portion of a string of query symbols is associated with a predefined spelling rule;
a means for searching the database according to the associated spelling rule; and
a means for outputting results based on the search.

20. The system of claim 1, further comprising:
a user interface component for generating an all query symbol that matches all the distinct letters, numbers, and symbols.

21. A method of searching a database, the method comprising:
storing a plurality of records, each record includes one or more tokens, wherein the one or more tokens include one or more letters, numbers, or symbols;
generating at least one of a query symbol or a string of query symbols using two or more input keys, wherein each input key is associated with a query symbol and the number of input keys is less than the number of distinct letters, characters, and symbols;
comparing the generated query symbol or string of query symbols to the stored records; and
if based on the comparison the query symbol or string of query symbols match the token or tokens of a record, outputting the record or records having the matching tokens on a display associated with the input keys.

22. A system for searching a database, the system comprising:
a means for storing a plurality of records, each record includes one or more tokens, wherein the one or more tokens include one or more letters, numbers, or symbols;
a means for generating at least one of a query symbol or a string of query symbols, the means for generating includes two or more input keys, wherein each input key is associated with a query symbol and the number of input keys is less than the number of distinct letters, characters, and symbols;
a means for comparing the generated query symbol or string of query symbols to the stored records; and
a means for outputting on a display the record or records having tokens that match the generated query symbol or string of query symbols based on the comparison.
